(19) United States
(12) Patent Application Publication
(10) Pub. No.: US 2017/0236221 A1
(43) Pub. Date: Aug. 17, 2017

(54) SYSTEM AND METHODS FOR VISUALIZATION OF SUPPLY CHAIN AND DATA PROCESSING OF RELATED TASKS AND EVENTS

(71) Applicant: NetSuite Inc., San Mateo, CA (US)

(72) Inventors: GAVIN DAVIDSON, Georgetown (CA); SUHAS ROHIT MEHTA, San Mateo, CA (US)

(21) Appl. No.: 15/089,037

(22) Filed: Apr. 1, 2016

Related U.S. Application Data
(60) Provisional application No. 62/145,321, filed on Apr. 9, 2015.

(51) Int. Cl. G06Q 50/04; G06Q 30/06; G06Q 10/08; G06Q 10/06

(52) U.S. Cl. CPC G06Q 50/04; G06Q 10/06313; G06Q 30/0633; G06Q 10/0875

(57) ABSTRACT

A more effective visual representation of the factors and parameters in a timeline that is involved in executing an overall process. Such a process may be a typically be a manufacturing process, but the process may be any in which materials and resources are used to produce an end product. In one embodiment, a computer-based system and computer-implemented method are directed to a generating a graphical representation or user interface that depicts a time-ordered sequence of sub-processes and parameters associated with those sub-processes. The parameters may include one or more of tasks, manufacturing processes, material consumed at a given time, material required to complete a process at a given time, the rate of material consumption at a given time, additional material needed (beyond that currently available to the process), availability of the additional material (based on current or near-current inventory levels, warehouse or storage locations), time to complete for a required inter-dependent related process or task, and the like. Such a system and method may take advantage of materials and resources that can be assembled in a list and associated with one or more time attributes.

### PRIORITY CLAIM

This application claims the benefit of U.S. Provisional Application No. 62/145,321, entitled “System and Methods for Visualization of Supply Chain and Data Processing or Related Tasks and Events,” filed Apr. 9, 2015, which is incorporated by reference in its entirety herein for all purposes.

### BACKGROUND

Production or work order management is an important aspect of most (if not all) manufacturing businesses. One of the most critical aspects of such management is to ensure that the proper types and amount of materials or parts have been acquired or produced, and have been transported to the location or locations where they will be needed to be used as part of the overall manufacturing process. This may require management of multiple internal and external operations including inspections, material or part testing, material or part preparation prior to being suitable for use in the overall process, identification of the location/process step where the material or part is needed, sensing/tracking of certain parameters of the sub-processes to ensure that the overall process is being executed properly, etc. Production management may also include various aspects of cost tracking, cost management, and cost optimization. In addition, some or all of these steps or stages may occur within an overall Project Management process where the manufacturing process is managed within a larger group of tasks, sub-tasks and processes that may not be directly related to a manufacturing or assembly process. For example, material or part costs and transportation costs may be an important aspect of the total cost and/or cash flow projections for a larger project.

In order to provide users with more effective tools for managing the production process, various types of graphical representations of a bill of material/work order have been developed. One of these is a graphical “bill of materials”, which attempts to display to a user the relationships between the steps or stages of a process or sub-process and the materials/parts required at that stage.

However, in a traditional graphical bill of materials, even If the materials are attached to an operation or routing step, the structure doesn't display to the user how the duration of the operation affects the way the materials are consumed (such as in terms of rate of material consumption or amount consumed (or required to complete the process) at any time). Additionally, the material itself may affect the overall timeline to complete the manufacturing process if that material and its availability affect other operations and tasks. This may be important information needed to manage production, particularly if additional materials need to be obtained from another location or are the result of a previous processing stage. Further, even temporary changes to the assumed operational parameters of the material transit or production phases used to supply the material to the operation step being analyzed may have an impact on the output or parameters of the operation step. For example, where the manufacturing process is managed within a larger project, any delay may in turn delay the overall project and subsequent tasks and/or billing milestones.

### BRIEF DESCRIPTION OF THE DRAWINGS

Embodiments of the subject matter disclosed herein in accordance with the present disclosure will be described with reference to the drawings, in which:

FIG. 1 is a diagram illustrating elements or components of an example operating environment in which an embodiment of the subject matter disclosed herein may be implemented;

FIG. 2 is a diagram illustrating additional details of the elements or components of the multi-tenant distributed computing service platform of FIG. 1, in which an embodiment of the subject matter disclosed herein may be implemented;

FIG. 3 is a diagram illustrating a simplified system of FIG. 1, including an integrated business system and an enterprise network in which an embodiment of the subject matter disclosed herein may be implemented;

FIG. 4(a) through FIG. 4(g) are diagrams illustrating visual representations of a process, sub-process, method, operation, or function for generating and using a display of a Supply Chain and the Data Processing of Related Tasks and Events, and that may be used when implementing an embodiment;

FIG. 5 is a flow diagram of a method for implanting a computer-based method for representing a visualization of a supply chain timeline according to an embodiment of the subject matter disclosed herein; and

FIG. 6 is a diagram illustrating elements or components that may be present in a computer device or system configured to implement a method, process, function, or operation in accordance with an embodiment.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present subject matter may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, or other form of computing or data processing device/platform and that is programmed with a set of executable instructions (e.g., software instructions), where the instructions may be stored in a suitable non-transitory data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

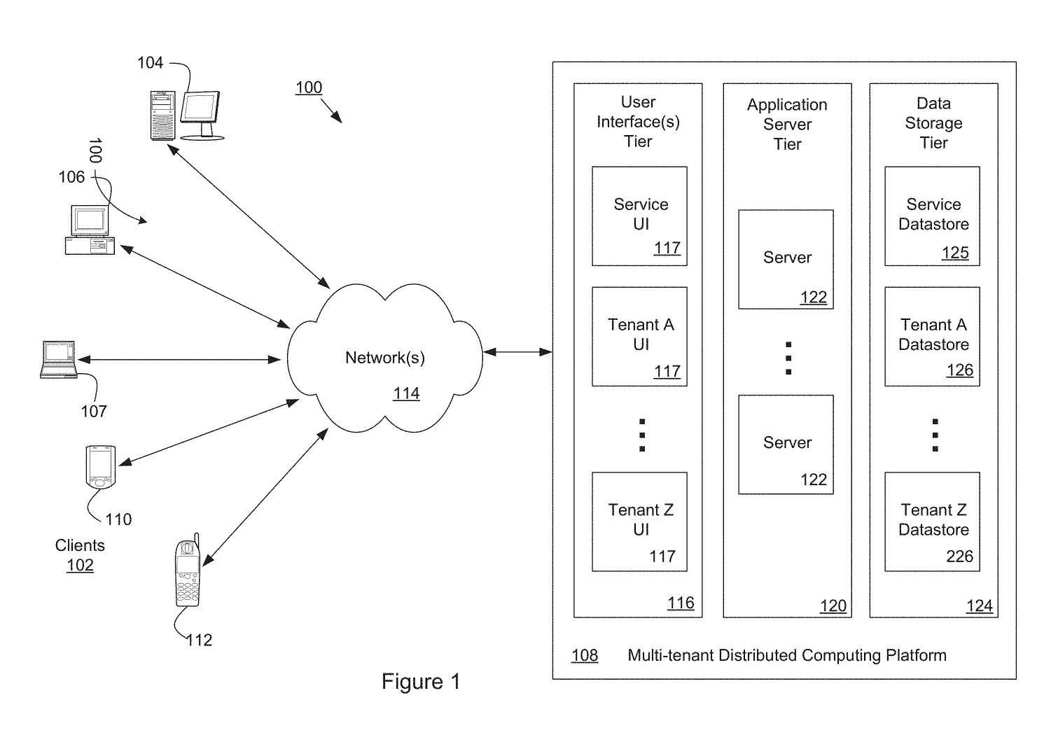

In some embodiments, the subject matter may be implemented in the context of a multi-tenant, “cloud” based environment (such as a mufti-tenant business data processing platform), typically used to develop and provide web services and business applications for end users. This exemplary implementation environment will be described with reference to FIGS. 1-7 below. Note that embodiments may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. With differing levels of overlap with ERP/CRM initiatives and with each other, efforts have also been directed toward development of increasingly integrated partner and vendor management systems, as well as web store/eCommerce, product lifecycle management (PLM), and supply chain management (SCM) functionality.

By way of overview, various embodiments as discussed herein are directed to systems, apparatuses, and methods for more effective visual representations of the factors and parameters involved in executing an overall process. Such a process may be a typically be a manufacturing process, but the process may be any in which materials and resources are used to produce an end product. In one embodiment, a computer-based system and computer-implemented method are directed to a generating a graphical representation or user interface that depicts a time-ordered sequence of sub-processes and parameters associated with those sub-processes. The parameters may include one or more of tasks, manufacturing processes, material consumed at a given time, material required to complete a process at a given time, the rate of material consumption at a given time, additional material needed (beyond that currently available to the process), availability of the additional material (based on current or near-current inventory levels, warehouse or storage locations), time to complete for a required inter-dependent related process or task, and the like. Such a system and method may take advantage of materials and resources that can be assembled in a list and associated with one or more time attributes.

In further embodiment, the systems and methods may be used for monitoring and/or controlling a manufacturing process, a transportation process, a production process, an assembly process, or any other suitable process, project, or task. In some embodiments, an implementation of the system and methods described herein may be used as part of, or in conjunction with, a multi-tenant business data processing platform. In such an embodiment, real-time or pseudo real-time business data may be provided to a data processor and then used as part of generating one or more elements of the visual display. Further, the processor may execute one or more instructions or routines that result in accessing information about events that may impact the monitored or controlled process, sub-processes, tasks, functions, or operations. These events or notifications may initiate a sub-process of the monitored or controlled process, or impact a parameter of a sub-process.

One featured aspect of various embodiments is the use of a central timeline during the design, build, use, simulation, and execution of the manufacturing process. In one embodiment, the timeline includes three sections that correspond to a time attributes of materials and resources that may be used in the process:
Before Start: Any task, material, operation or service in this section happens or is required before the actual start of the production process;
During Production: Any task, material, operation or service in this section is part of the production process; and
After Finish: Any task, material, operation or service in this section happens or is required after the end of the production process.
   The timeline progresses in a logical manner from left to right and the scale of time can be changed to accommodate any length of manufacturing process.

During the design process, tasks, materials, operations, or services are “dragged” onto the appropriate part of the timeline. In other embodiments, tasks, materials, operations, or services are automatically populated into a visual display of a process timeline based on a set of manufacturing instructions, bill of materials, or recipe. Operations, tasks, and services are ordered in the appropriate sequence from first to last/left to right, and materials that are required for a particular operation, task or service to be completed are attached by dragging them together.

In simulation mode, the tasks, operations or services that appear on the timeline are evaluated and automatically identified as being part of the critical path (this may also be the result of application of a rule set or condition, where the critical path is a term commonly used in project management to determine the sequence of events that must be completed in time for the overall project to be completed). However, in this case, a material can also be part of the critical path if the material's availability impacts the overall completion or timing of the manufacturing process.

In one embodiment, any task, material, operation, or service that is on the timeline will be “flagged” as critical and work orders, travelers, operators, vendors, and purchase orders that relate to critical path items are “flagged” or otherwise identified. In one embodiment, vendors will be notified automatically by email or through alerts pushed to the vendor portal when a purchase order is pending or placed for a critical path item. Updates to a critical path element that affect the completion date/availability (e.g., transactional information, vendor delivery updates, purchase order receipts, and the like) will automatically adjust the elements and processes displayed on the timeline.

As part of a project, multiple work orders can be grouped together to display a project timeline with a critical path. Additionally, in some embodiments, there is an ability to group less related or unrelated work orders into a schedule group that would also be the subject of a critical path timeline. In this way, some tasks, materials, operations, or services may appear as part of multiple schedule groups and appear on the critical path timeline in some, but not others. If a task, material, operation, or service appears on the timeline in any group/work order, it will be flagged as a critical path element. In one embodiment, the greater the number of timelines on which a task, material, operation, or service appears, the more critical it will become and the relative priority of that element will be increased.

For example, a CRM (customer relationship management) application may generate a notification of a new sale of a certain number of units of a product (or generate a query to the application), which then initiates the a set of sub-processes that determine the availability of the finished products, and if manufacturing or assembly is required, what materials or parts are needed, when during the overall process they are needed, where they are needed, and any other relevant operational parameters. The sub-processes may include ones that query or determine aspects of an ERP (enterprise resource planning) application or related data in order to determine inventory levels, material in transit, location of warehouses, and the like, as part of the overall planning and scheduling of the delivery of the units of product.

Other objects and advantages will be apparent to one of ordinary skill in the art upon review of the detailed description and the included figures.

Prior to discussing the embodiments, FIGS. 1-3 are presented to show an exemplary computing environment in which one or more embodiments may be practiced and realized.

FIG. 1 is a diagram illustrating elements or components of an example operating environment in which an embodiment may be implemented. In FIG. 1, an example operating environment 100 includes a variety of clients 102 incorporating and/or incorporated into a variety of computing devices that may communicate with a distributed computing service/platform 108 through one or more networks 114. For example, a client may incorporate and/or be incorporated into a client application (e.g., software) implemented at least in part by one or more of the computing devices. Examples of suitable computing devices include personal computers, server computers 104, desktop computers 106, laptop computers 107, notebook computers, tablet computers or personal digital assistants (PDAs) 110, smart phones 112, cell phones, and consumer electronic devices incorporating one or more computing device components, such as one or more electronic processors, microprocessors, central processing units (CPU), or controllers. Examples of suitable networks 114 include networks utilizing wired and/or wireless communication technologies and networks operating in accordance with any suitable networking and/or communication protocol (e.g., the Internet).

The distributed computing service/platform (which may also be referred to as a multi-tenant business-data-processing platform) 108 may include multiple processing tiers, including a user interface tier 116, an application server tier 120, and a data storage tier 124. The user interface tier 116 may maintain multiple user interfaces 117, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, and the like. Each processing tier shown in FIG. 1 may be implemented with a set of computers and/or computer components including computer servers and processors, and may perform various functions, methods, processes, or operations as determined by the execution of a software application or set of instructions. The data storage tier 124 may include one or more data stores, which may include a service data store 125 and one or more tenant data stores 126.

Each tenant data store 126 may contain tenant-specific data that is used as part of providing a range of tenant-specific business services or functions, including but not limited to ERP, CRM, eCommerce, Human Resources management, payroll, and the like. Data stores may be implemented with any suitable data storage technology, including structured query language (SQL) based relational database management systems (RDBMS).

In accordance with one embodiment, the distributed computing service/platform 108 may be a multi-tenant and service platform 108 and may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an ERP system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 122 that are part of the platform's Application Server Tier 120.

Another business information system that may be provided as part of an integrated data processing and service platform is an integrated CRM system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support returns management authorization (RMA), loyalty program support, and web-based customer support, as well as reporting and analysis capabilities relating to these functions. In addition to ERP and CRM functions, a business information system/platform (such as element 108 of FIG. 1) may also include one or more of an integrated partner and vendor management system, eCommerce system (e.g., a virtual storefront application or platform), product lifecycle management (PLM) system, Human Resources management system (which may include medical/dental insurance administration, payroll, and the like), or supply chain management (SCM) system. Such functions or business applications are typically implemented by one or more modules of software code/instructions that are maintained on and executed by one or more servers 122 that are part of the platform's Application Server Tier 120.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients,” Depending on the computing service that a server offers it could be referred to as a database server, file server, mail server, print server, web server, and the like. A web server is a most often a combination of hardware and the software that helps deliver content (typically by hosting a website) to client web browsers that access the web server via the Internet.

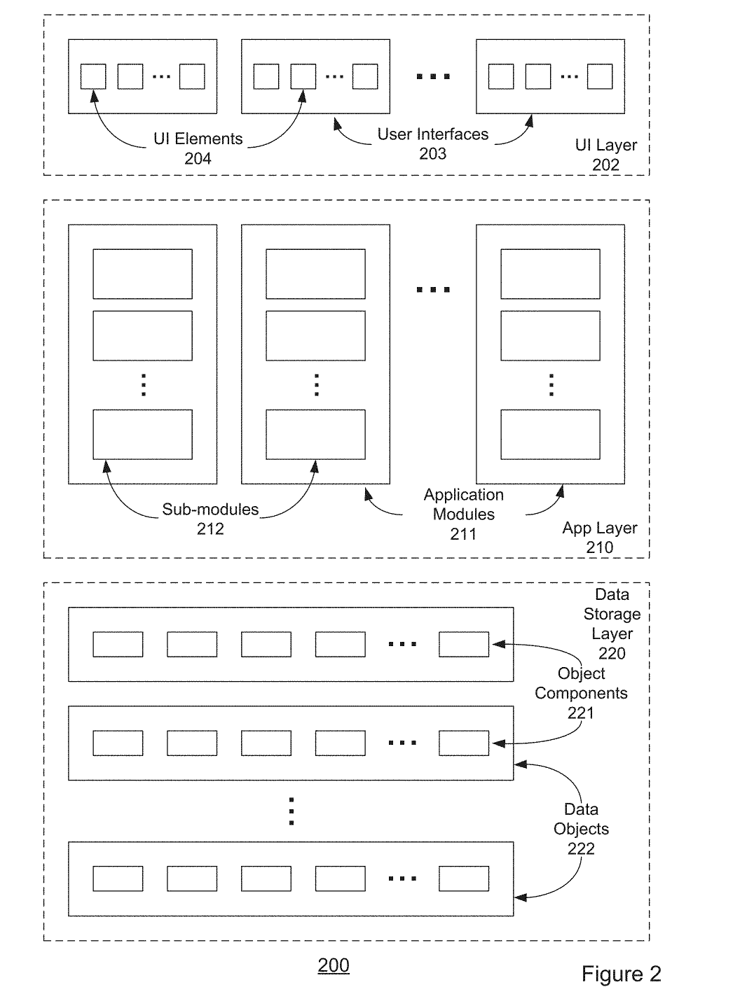

Rather than build and maintain such an integrated business system themselves, a business may utilize systems provided by a third party. Such a third party may implement an integrated business system as described above in the context of a multi-tenant platform, wherein individual instantiations of a single comprehensive integrated business system are provided to a variety of tenants. However, one challenge in such multi-tenant platforms is the ability for each tenant to tailor their instantiation of the integrated business system to their specific business needs. In one embodiment, this limitation may be addressed by abstracting the modifications away from the codebase and instead supporting such increased functionality through custom transactions as part of the application itself. Prior to discussing additional aspects of custom transactions, additional aspects of the various computing systems and platforms are discussed next with respect to FIG. 2.

FIG. 2 is a diagram illustrating additional details of the elements or components of the distributed computing service platform of FIG. 1, in which an embodiment may be implemented. The software architecture depicted in FIG. 2 represents an example of a complex software system to which an embodiment may be applied. In general, an embodiment may be applied to any set of software instructions embodied in one or more non-transitory, computer-readable media that are designed to be executed by a suitably programmed processing element (such as a CPU, microprocessor, processor, controller, computing device, and the like). In a complex system such instructions are typically arranged into “modules” with each such module performing a specific task, process, function, or operation. The entire set of modules may be controlled or coordinated in their operation by an operating system (OS) or other form of organizational platform.

In FIG. 2, various elements or components 200 of the multi-tenant distributed computing service platform of FIG. 1 are shown, in which an embodiment may be implemented. The example architecture includes a user interface layer or tier 202 having one or more user interfaces 203. Examples of such user interfaces include graphical user interfaces and application programming interfaces (APIs). Each user interface may include one or more interface elements 204. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 210 may include one or more application modules 211, each having one or more sub-modules 212. Each application module 211 or sub-module 212 may correspond to a particular function, method, process, or operation that is implemented by the module or sub-module (e.g., a function or process related to providing ERP, CRM, eCommerce or other functionality to a user of the platform). Such function, method, process, or operation may also include those used to implement one or more aspects of the inventive system and methods, such as for:

Generating a user interface to permit the user to construct a timeline illustrating one or more selected operations or processes, with the operations or processes typically being part of a manufacturing, assembly, product development, project or similar process;

Enabling the user to link or otherwise associate one or more of the selected operations or processes with a material, element, or sub-process that is needed in order to properly execute the operation or process;

Automatically or at the direction of the user, associating the material, element, or sub-process with one or more data records or parameters, where such data records or parameters may be evaluated, determined, calculated, or revised as a result of the operations of a business data processing platform;

Automatically calculate the importance of a task, material, operation or service based on how many timelines it appears on; and

Allowing a user to create a schedule group of otherwise unrelated (or loosely related) work orders and having a critical path timeline associated with that group to analyze how these orders interact and affect each other in terms of the overall schedule.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 122 of FIG. 2) may include each application module. Alternatively, different application servers may include different sets of application modules. Such sets may be disjoint or overlapping.

The data storage layer 220 may include one or more data objects 222 each having one or more data object components 221, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

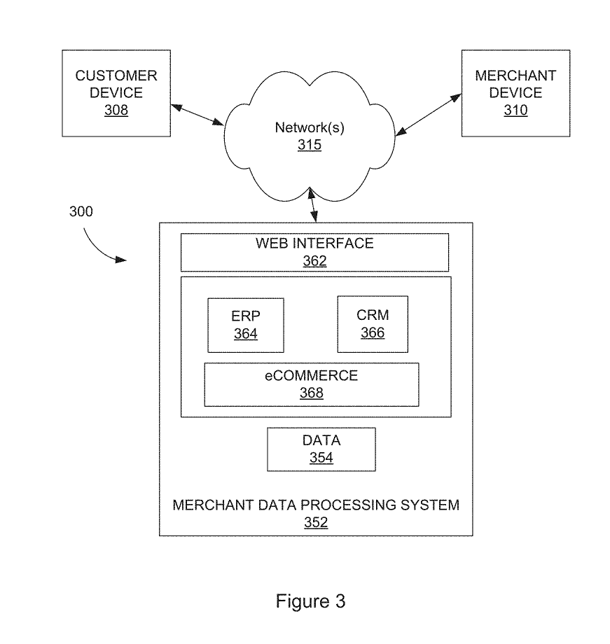

FIG. 3 is a diagram illustrating another perspective of a computing or data processing environment 300 in which an embodiment may be implemented. FIG. 3 illustrates a merchant's data processing system 352, where such a platform or system may be provided to and operated for the merchant by the administrator of a multi-tenant business data processing platform. Thus, the merchant may be a tenant of such a multi-tenant platform, with the elements that are part of system 352 being representative of the elements in the data processing systems available to other tenants. The merchant's data is stored in a data store 354, thereby permitting customers and employees to have access to business data and information via a suitable communication network or networks 315 (e.g., the Internet). Data store 354 may be a secure partition of a larger data store that is shared by other tenants of the overall platform.

A user of the merchant's system 352 may access data, information, and applications (i.e., business related functionality) using a suitable device or apparatus, examples of which include a customer computing device 308 and/or the Merchant's computing device 310. In one embodiment, each such device 308 and 310 may include a client application such as a browser that enables a user of the device to generate requests for information or services that are provided by system 352. System 352 may include a web interface 362 that receives requests from users and enables a user to interact with one or more types of data and applications (such as ERP 364, CRM 366, eCommerce 368, or other applications that provide services and functionality to customers or business employees).

Note that the example computing environments depicted in FIGS. 1-3 are not intended to be limiting examples. Alternatively, or in addition, computing environments in which embodiments may be implemented include any suitable system that permits users to access, process, and utilize data stored in a data storage element (e.g., a database) that can be accessed remotely over a network. Although further examples below may reference the example computing environment depicted in FIGS. 1-3, it will be apparent to one of skill in the art that the examples may be adapted for alternate computing devices, systems, and environments.

As described herein, one or more of the functions, operations, processes, or methods used to implement an embodiment may be provided by an extension to an existing application, process, function, operation, etc. In such an implementation, aspects of the inventive display may be provided as an extension to the operations of a multi-tenant business data processing platform or other suitable data processing system.

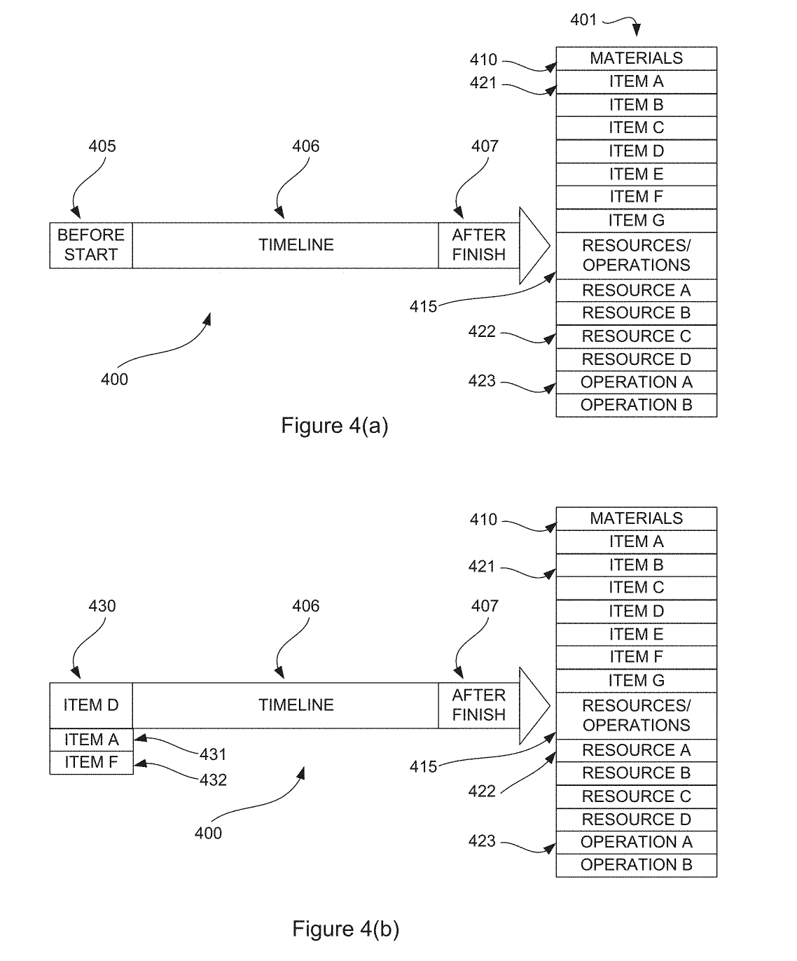

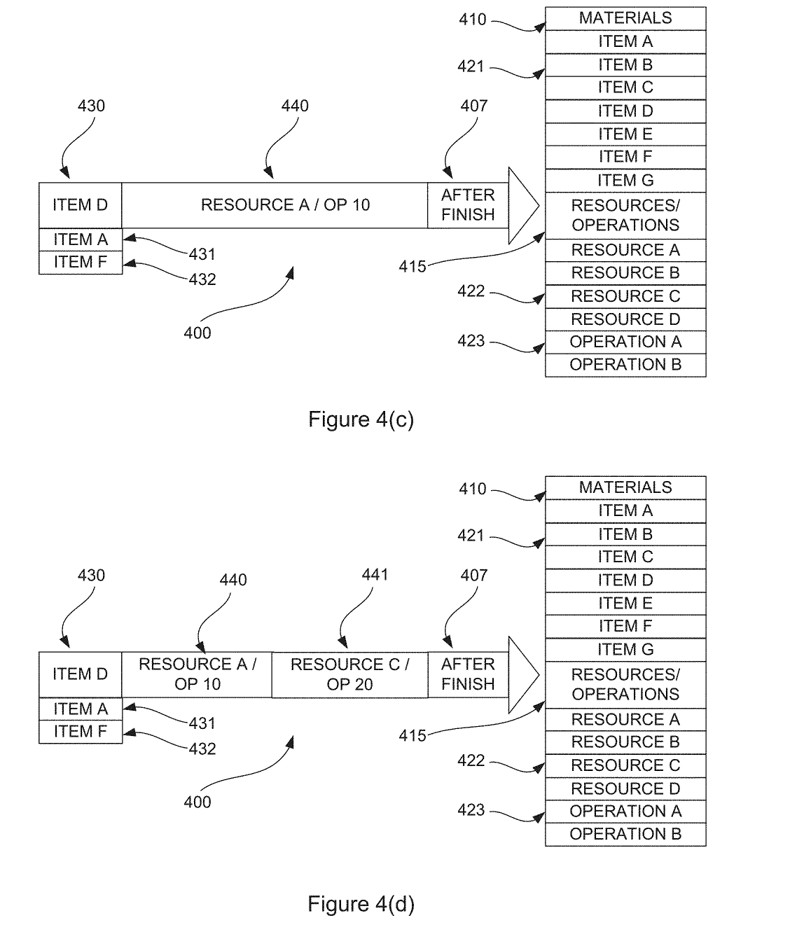

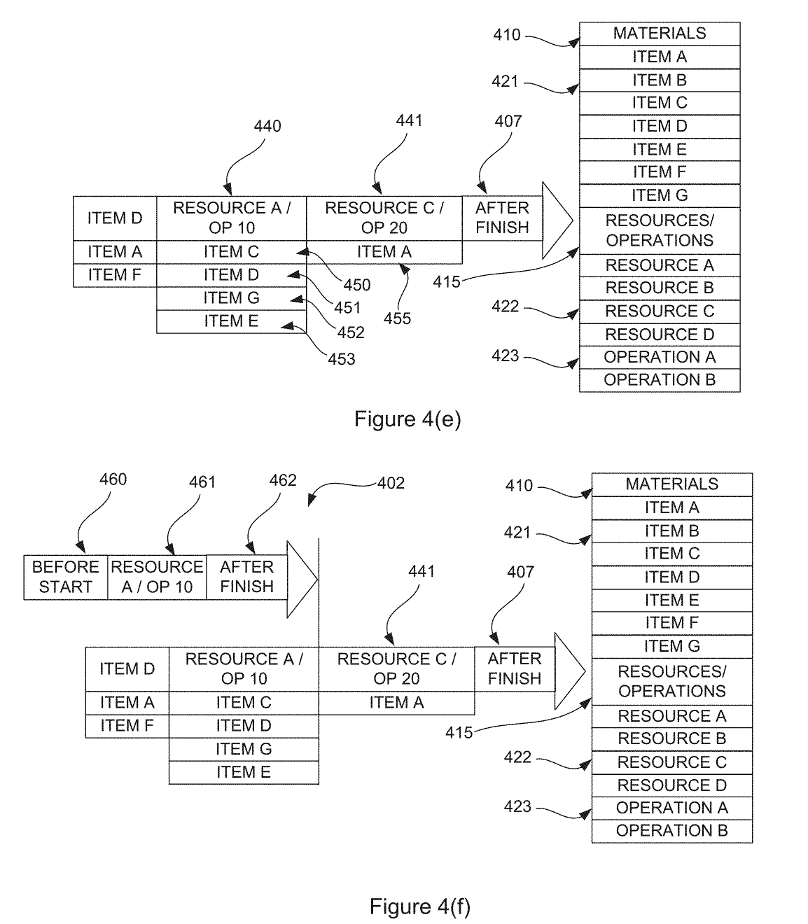

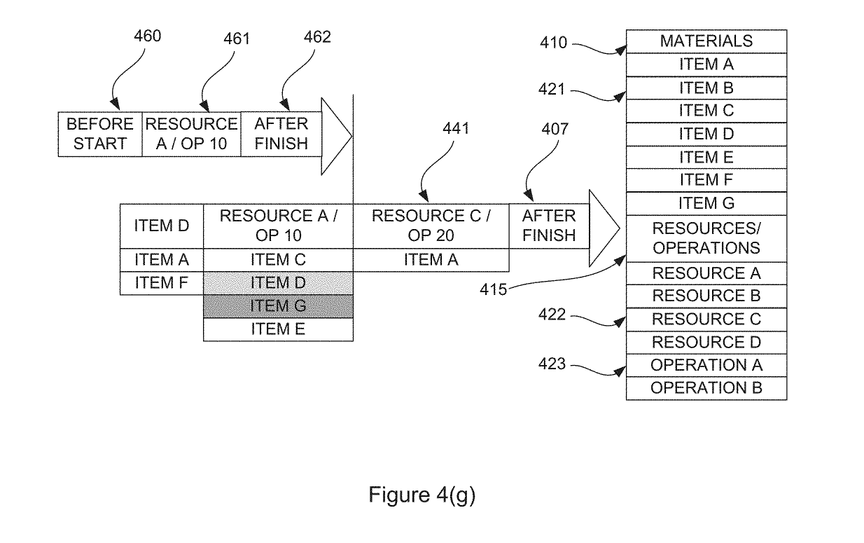

FIGS. 4(a)-4(g) diagrams illustrating visualizations of a process, sub-process, method, operation, or function for generating and using a display of a supply chain and the data processing of related tasks and events, and that may be used when implementing an embodiment. Project management is an important aspect of most (if not all) manufacturing processes. This is due in part to the need to ensure that the types and amount materials or parts have been acquired or produced, and transported to the location or locations where they will be needed to be used as part of the overall process. This may require management of multiple sub-tasks, such as inspections, material or part testing, material or part preparation prior to being suitable for use in the overall process, identification of the location/process step where the material or part is needed, sensing/tracking of certain parameters of the sub-processes to ensure that the overall process is being executed properly, etc. Project management may also include various aspects of cost tracking, cost management, and cost optimization.

In order to provide users with more effective tools for managing projects or tasks, various types of graphical representations of a project have been developed. One of these is a graphical “bill of materials”, which attempts to display to a user the relationships between the steps or stages of a process or sub-process and the materials/parts required at that stage.

However, a traditional graphical bill of materials, even If the materials are attached to an operation/routing step, doesn't display to the user how the duration of the operation affects the way the materials are consumed (such as in terms of rate or amount). This may be important information needed to manage a project, particularly if additional materials need to be obtained from another location or are the result of a previous processing stage. Further, even temporary changes to the assumed operational parameters of the material transit or production phases used to supply the material to the operation step being analyzed may have an impact on the output or parameters of the operation step.

By re-orienting a traditional bill of material/work order view with the finished goods on the right side and the materials and operations aligned based on time, possible conflicts and effects of late orders are easier to identify. This arrangement offers the ability to time the order/release of materials based on the timeline, not a specific operation. FIGS. 4(a)-4(g) show one embodiment of the bill of materials view of a process.

When a user engages an exemplary method for timeline visualization of a process, a number of data points may be assembled such that a user can see a listing of possible items in an item list 401. The item list 401 may sometimes be called the “gutter” and may appear in any orientation in a visualization such as on the right side as shown in FIG. 4(a). The items in the item list 401 may be raw materials 410 that can be used in any process. For example, item A 421 may be the raw material of a printed circuit board that may be needed to begin assembly of a radio.

Further, the items in the item list 401 may be resources 415 that may be consumed at a particular rate during a process. For example, resource A 422 may be solder that may be consumed during a manufacturing process. Further yet, the items in the item list 401 may be operations that comprise both raw materials and resources. For example, operation A 423 may be the operation of soldering a capacitor to a printed circuit board. Generally speaking, a material 410 may be an item that is needed for in order to begin a process or finish a process and a resource 415 may be an item needed during an operation of the process.

Items in the item list 401 may have attributes associated with time. In an embodiment, each item may have an attribute indicating that the item is needed for a particular process before the process starts. Further, each item may have an attribute indicating that the item is needed for a particular process after the process ends. Further yet, each item may have an attribute indicating that the item is needed for a particular process while the process is being carried out. These time attributes may be used in conjunction with a visual representation of a timeline 400. The timeline itself may have a number of time periods including a first time period 405 associated with before starting the process, a second time period 406 associated with during the process, and a third time period 407 associated with after the process ends. Each item in the item list 401 may have different attributes associated therewith for different processes. Thus, if a visualization is to be created for a specific process, a specific process-based set of attributes are used in conjunction with any items in the item list 401. Then, a user may generate a new bill of materials (BOM), through this interface that features the central timeline 400 along with the list of items 401.

In FIG. 4(b), a user may begin populating a visualization of a process (and thereby beginning a bill of material and or a work order) by dragging various items from the item list 401 to the timeline 400. For example, in FIG. 4(b), the user may decide that items A, D, and F are needed before the new process starts. By dragging items A, D and F from the item list 401 to the first time period 405, the visualization shows each dragged item within this first time period 405 as item D 430, item A 431 and item F 432.

In an embodiment, the system may automatically determine which item to show in the body of the timeline 400 (as opposed to below the timeline). Such a determination of which item is displayed in the timeline may be a function of lead time or availability. Items having the longest lead time or the longest delay prior to availability may appear in the timeline 400 as this item creates the most impact on the length of the timeline. An availability or lead-time of the particular item may vary if the item is a special order item or one not typically in inventory. This aspect of how and what to display makes it easier for the user to understand which materials could be constraints on the overall timeline 400 and a critical path for the process. Thus, in the embodiment shown in FIG. 4(b), item D 430 is shown in the timeline as having the longest lead time and items A 431 and F 432 are shown below as not impacting the critical path of the timeline.

In other embodiments, how an item is placed into a timeline 400 and what items are displayed in a timeline 400 may be a function of a number of different attributes. For example, current inventory amount may affect how and where the items are displayed. Further, an assigned level of importance may affect the overall display in a timeline. Further yet, an average cost of the item may also affect how the item is displayed with higher cost items making up a critical path in terms of costs for a process.

In the next view of this sequence, FIG. 4(c) shows that the system and/or a user continues by adding tasks, pre-configured operations, or services that are to be performed and/or purchased to the timeline. The graphical way that this is represented in an easy to read left-to-right orientation is an aspect that will make the process easier to understand as it is built. In one embodiment then, a user may drag a resource or an operation from the item list 401 into the second period 406 of the timeline 400. If a resource is selected for populating the second period of the timeline (i.e., as shown, resource A is selected and dragged over in to the only position 440), the entire second period then becomes an operation associated with the selected resource (as shown—resource A/operation 10 440). Having only one resource/operation 440 means that the critical path necessarily includes the one resource/operation. If a user drags an operation to the second period 406 of the timeline 400, associated resources that are linked to the stored operation from the item list 401 may also be automatically populated here as well.

In FIG. 4(d), one can see that dragging additional resources and/or operations, to the second period 406 of the timeline 400 will start to build up the overall process flow, and the operations will stretch out to consume 100% of the length of the timeline 400. For example, a second resource C 441 may be dragged over to the second period 406 of the timeline 400. In this example, the resource C may be associated with another new operation 20. Further, as shown operation 20 may be dependent on operation 10 such that operation 20 cannot start until operation 10 is finished. Thus, operation 20 appears subsequent to operation 10 in the second period 406 of the timeline. The way the resources and operations consume the second period of the timeline 400 and relative proportions can be adjusted based on relative time or estimated cost (depending on the view desired). The system may also automatically calculate the total duration and cost of the manufacturing process and display both for the user based on the different resources and operations in the second period 406 of the timeline 400.

FIG. 4(e) shows a view of the visual representation where specific items may also be shown associated with the resources and/or operations that are used in the second period 406 of the timeline 400. In one embodiment, dragging materials that are required as part of the manufacturing process onto the relevant operation will link them together, indicating that the material is required to complete the task, operation, or service. Additionally, materials can be timed for consumption and/or ordering based on the expected start or completion of the manufacturing process. This aspect may involve use of a formula, rule set, or conditions, and can be defined to determine when material is required based on any relevant parameter Such parameters may be, for example, start of work, lead-time, additional days, hours, minutes, end of work, combinations thereof, and the like.

In another embodiment, various items that may have already been associated with an operation may then be shown below the timeline. To this end, the item amongst all items associated with an operation may be shown ion the critical path portion of the second period 406 of the timeline 400. For example, in FIG. 4(e), items C 450, G 451, D 452 and E 453 are associated with resource A/operation 10 440. Thus, they are shown below the timeline in a position with respect to resource A/operation 10 440. Similarly, item A 455 is shown below resource C/operation 20 441.

FIG. 4(f) shows a visual representation of an additional feature of the timeline 400 wherein a secondary timeline 402. In this embodiment, if an item that is dragged to the timeline 400 is, in and of itself, manufactured or assembled, then the secondary timeline 402 for that item may be shown superseding the second time period 406 corresponding to the item from the initial timeline 400. Similar display rules (as discussed above with respect to the timeline 400) may also apply for determining when that assembly item is required as above. Thus, the secondary timeline 402 may include a secondary first period 460 of time for items needed before start, a secondary second period 461 of time for items needed during the process and a secondary third period 462 of time for items needed after the finish of the process.

FIG. 4(g) shows and overall resulting visual representation of a timeline 400 for a particular process. This view may also generate a resulting work order view that dictates the overall manufacturing process and is dynamic, with tasks, materials, operations, and services automatically moving on and off of the timeline based on how they are currently affecting the work order and the timeline 400. Thus, as different items are used up or no longer available, the critical path may shift within this view as variations in these items become part of the critical path. Further, the critical path may be identified by color coding of the various visual representation. In this manner, one can easily identify which item(s) may be affecting the critical path within each of the timeline 400 three time periods 405, 406 and 407.

The timeline/critical path can and typically will contain a combination of items, materials, operations, and services. Various items that appear in the critical path may also automatically generate specific system actions as a result of being identified as part of a critical path. In one embodiment, if an item appears in a critical path, an electronic notification can be generated and communicated internally to other users or systems or may be sent externally to vendors or partners to indicate the importance of any given element being completed/delivered in a timely manner. These notifications may be email, alert driven, or displayed in portals for ease of consumption. Further, such notifications may be a purchase order to a vendor or partner if inventory identifies a shortage of the needed item.

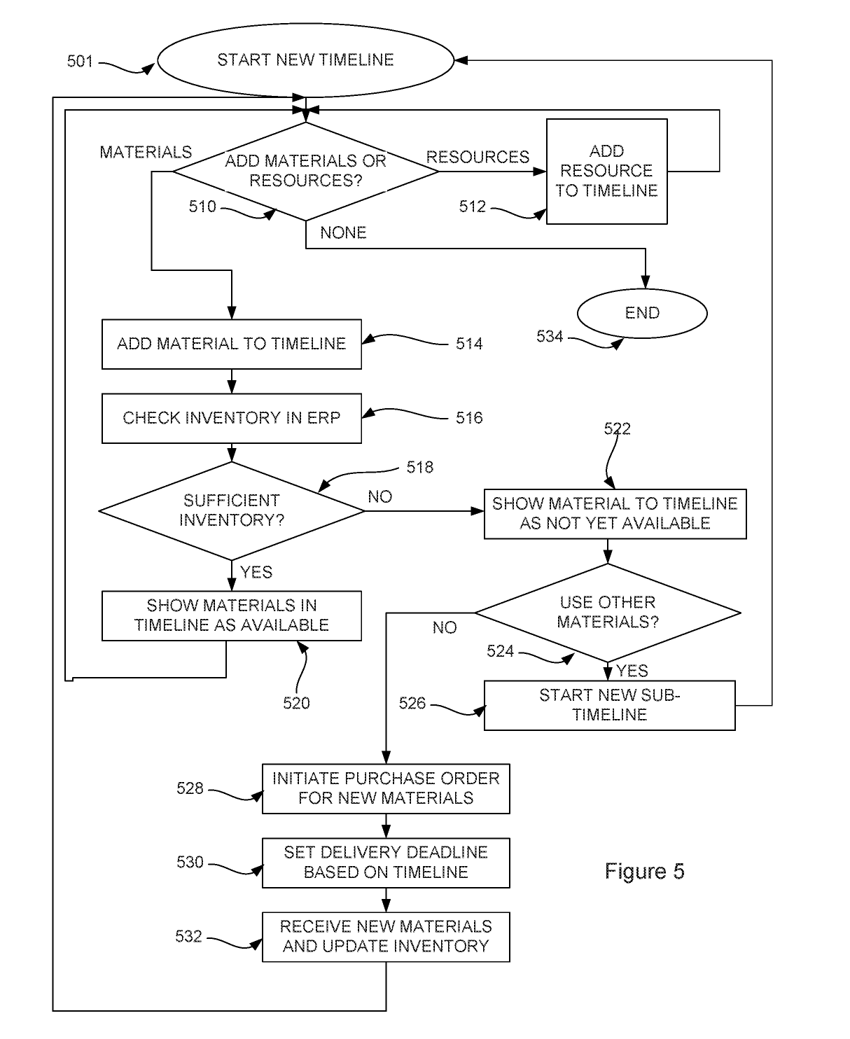

FIG. 5 is a flow diagram of a method for implementing a computer-based method for representing a visualization of a supply chain timeline according to an embodiment of the subject matter disclosed herein. FIG. 5 shows one embodiment of such a method, however various additional methods may include further steps or fewer steps as well as steps arranged in different orders than what is shown in this embodiment.

The method of FIG. 5 may start at step 501 wherein a creator creates a new process. A new timeline may be established with respective time periods as discussed above, e.g., before start, during production and after finish. At step 510, the creator may choose one of three actions, to add a material, to add a resource/operation or to not add anything (in which case the overall method finishes at step 534). If a resource/operation is added, the method branches to the right for adding the resource/operation to the timeline at step 512 and then loops back to the creator query 510. If the creator chooses to add a material, the method branches to the left for a several additional steps. Material and resources may be added either by drag and drop or by any other functionality supported by the underlying programming.

If the creator chooses to add a material to the timeline through the left-side branch at query 510, the material is added to the timeline at step 514. But then, the method may also check the availability of the material by accessing an inventory system at step 516 within the ERP system to determine whether sufficient inventory exists for the intended use in this process. At query 518, the inventory system answers that there is sufficient inventory in the YES branch such that the material is then displayed in the timeline as available at step 520. The method then loops back to the initial add query at step 510.

If the inventory system determines that the material is not sufficiently stocked, another series of steps may be invoked through the NO branch starting with displaying the material on the timeline as unavailable at step 522. Such a step may also include changing an aspect to the displayed material, such as a color or location (e.g., an available material may be shown in green while an unavailable item may be shown in red—a material close to being unavailable may be shown in yellow). In other embodiments, when available items are less than a specific threshold (e.g., enough to finish a manufacturing run) then, the items may be considered unavailable. In some cases, the threshold may be set to a number that is at least as many as required to fulfill an order under processing. In some other case, the number may be 50% of the required quantity to fulfill an order because a purchase order may be in place to acquire more items. In the latter case, the system may fulfill as much of a full order as possible using the available items. If the material is unavailable, another query may occur at step 524 wherein a determination is made about any need for additional materials required for the initially unavailable material. Such a situation may occur if the initial unavailable material is also a locally made materials that may require additional materials. If the unavailable material now shown in the timeline after step 522 requires an additional process, a secondary timeline may be created and displayed at step 526. The secondary timeline may be displayed at step 526 in connection with the initial timeline and in a temporal context (as generally shown in FIG. 4(f)). Once the raw material is manufactured it is added to the local inventory. The change in inventory levels will be reflected by the updated color coding or other suitable indicator. The timeline will not complete until the required raw material is made available. The method may then loop back to query 510.

If no additional materials are needed for the unavailable material via the query at step 524, then the material may need to be put on order. The method may then automatically generate a purchase order (via a communicatively coupled purchase order computing system) at step 528. This may involve an automatic generation of an electronic communication and an arrangement for financial remuneration to one or more external entities. The purchase order may also include a delivery deadline that is based on the process timeline at step 530. Further, the method may then continue here when the material is received and the timeline may be updated (or inventory may be may updated as well) at step 532. The method may loop back around to initial query 510.

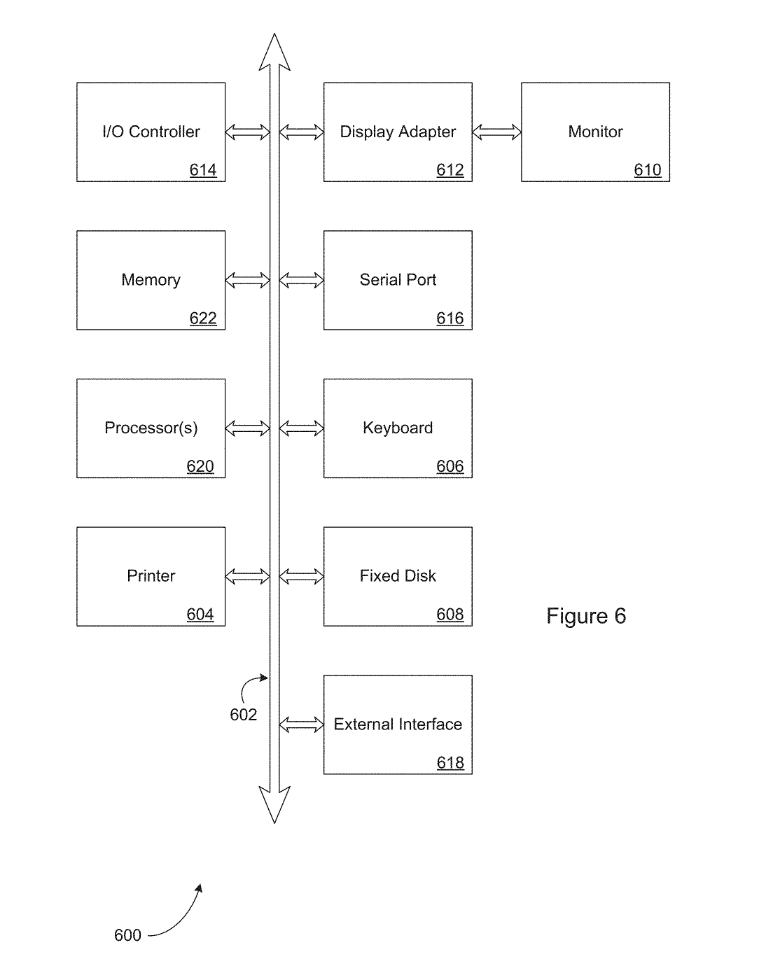

In accordance with one embodiment, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 6 is a diagram illustrating elements or components that may be present in a computer device or system 600 configured to implement a method, process, function, or operation in accordance with an embodiment. The subsystems shown in FIG. 6 are interconnected via a system bus 602. Additional subsystems include a printer 604, a keyboard 606, a fixed disk 608, and a monitor 610, which is coupled to a display adapter 812. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to further devices and/or systems not shown in FIG. 6 including a wide area network such as the Internet, a mouse input device, and/or a scanner. The interconnection via the system bus 602 allows one or more processors 620 to communicate with each subsystem and to control the execution of instructions that may be stored in a system memory 622 and/or the fixed disk 608, as well as the exchange of information between subsystems. The system memory 622 and/or the fixed disk 808 may embody a tangible computer-readable medium.

It should be understood that the present disclosures as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g.; meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A computer-implemented method for an improved use of process data, the method comprising:
assembling a timeline for a process, the timeline including a plurality of time periods;
assembling a list of items for the process, each item including at least one time attribute corresponding to a respective time period for the process;
generating a visual image of the timeline having each of the plurality of time periods shown associated with at least one item corresponding to the time period with respect to the timeline for the process; and
visually representing a critical path with a respective item for each of the plurality of time periods.

2. The computer-implemented method of claim 1, wherein one of the plurality of time periods comprises a time period prior to starting the process such that items that are needed for the process prior to starting the process have a time attribute corresponding to the prior to starting time period.

3. The computer-implemented method of claim 1, wherein one of the plurality of time periods comprises a time period after finishing the process such that items that are needed for the process after finishing the process have a time attribute corresponding to the after finishing time period.

4. The computer-implemented method of claim 1, wherein one of the plurality of time periods comprises a time period during the process such that items that are needed during the process have a time attribute corresponding to the time period during the process.

5. The computer-implemented method of claim 4, wherein at least one of the items needed during the process comprises an operation that consumes resources.

6. The computer-implemented method of claim 1, further comprising communicating with an inventory computer system to determine if one or more of the list of items are available prior to determining the critical path.

7. The computer-implemented method of claim 1, further comprising highlighting items in the timeline corresponding to the determined critical path.

8. The computer-implemented method of claim 1, further comprising communicating with a purchase order computer system to automatically generate a purchase order for items determined to be in the critical path.

9. The computer-implemented method of claim 1, further comprising automatically generating a bill of materials after determining the critical path.

10. The computer-implemented method of claim 1, further comprising:
determining that at least one item needed for a process comprises a second process;
assembling a second timeline for the second process, the second timeline including the plurality of time periods;
assembling a second list of items for the second process, each item in the second list including at least one time attribute corresponding to a respective time period for the second process; and
generating a visual image of the second timeline with respect to the first timeline.

11. An improved multi-tenant distributed computer system, comprising:
a database of items, each item in the database of items having at least one time attribute that corresponds to one of three time periods associated with a process, the time periods including a before start time period, a during processing time period and an after finish time period;
a processor coupled to the database and configured to retrieve items from the database corresponding to a process to be visually represented; and
a display configured to the controlled by the processor such that the display renders a visual representation of the process showing a timeline having three time periods corresponding to the three time periods associated with the process.

12. The computer system of claim 11, further comprising an inventory computer system communicatively coupled to the improved computer system, the inventory computer system configured to track items corresponding to the process and configured to determine if items needed for the process are available.

13. The computer system of claim 12, further comprising a purchase order computer system communicatively coupled to the improved computer system, the purchase order computer system configured generate a purchase order for an item determined by the inventory system to be unavailable.

14. The computer system of claim 11, wherein the processor is further configured to determine a critical path based on each time attribute associated with each needed item in the process such that the display renders the items associated with the critical path differently when compared to item that are not part of the determined critical path.

15. The computer system of claim 11, wherein the processor is further configured to generate a bill of materials after determining the critical path and to electronically communicate the bill of materials to an appropriate individual.

16. The computer system of claim 11, wherein the processor is further configured to update an inventory computer system when the process is invoked, the updating including communicating use of items from the database corresponding to the process.

17. The computer system of claim 11, wherein the processor is further configured to update the visual representation of the process in response to a use of items from the database by another concurrently running process.

18. A computer-implemented method for generating a bill of materials, the method comprising:
selecting a process to visually represent in a timeline on a computer display;
generating an item list, each item in the item list have at least one time attribute corresponding to one of three time periods linked to the process;
populating the timeline with items from the item list, each item places in one of the three time periods;
determining a time value for each item placed in timeline;
determining the item in each time period having the greatest time value and highlighting the respective highest time value item as a critical path; and
finalizing the timeline and generating a bill of materials based on the finalized timeline.

19. The computer-implemented method of claim 18, wherein the three time periods correspond to a first time period before starting the process, a second time period during the process, and a third time period after the process is finished.

20. The computer-implemented method of claim 18, wherein the items in the list of items comprise one of the group including: a raw material, a resource, an operation, a second process, a machine, a worker, a team, a department, and another computer system.

21. The computer-implemented method of claim 18, wherein the time value comprises one of the group including: a value corresponding to rate of consumption during a process, a number of items in an inventory, a lead time for producing the item, a lead time for purchasing the item, and a lag time for waiting on a related item.
